(19) United States
(12) Patent Application Publication
(10) Pub. No.: US 2009/0059898 A1
(43) Pub. Date: Mar. 5, 2009

(54) Method and Apparatus for Signaling the Subscriber Type of IP and Non-IP Subscribers Using the Hostpart of the SIP URI

(75) Inventors: Charles Chaney, Parkland, FL (US); Lawrence Logue, Boca Raton, FL (US); Frank Wesolowski, Coral Springs, FL (US)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 11/885,647

(22) PCT Filed: Mar. 6, 2006
(86) PCT No.: PCT/EP2006/002030

§ 371 Date: May 7, 2008

Related U.S. Application Data
(60) Provisional application No. 60/659,327, filed on Mar. 7, 2005.

(51) Int. Cl. H04L 12/66

(52) U.S. Cl. 370/352

(57) ABSTRACT

To identify a subscriber type of IP and non-IP subscribers with SIP without adding additional signaling elements to existing SIP headers, a method for identification of subscriber type with SIP makes use of the originating subscriber URIs are in form of userpart@hostpart. The userpart uniquely identifies the originating subscriber. A first switch identifies itself to a second switch through the hostpart. The first switch signals via SIP to the second switch the originating subscriber-type by using the hostpart to define a logical grouping identifying the originating subscriber-type.

The present invention relates to a method according the preamble of claim 1 and a system according the preamble of claim 11.

Session Initiation Protocol (SIP) is a standard signaling protocol used for establishing, in an IP network, interactive user sessions involving multimedia elements.

User sessions may range from a simple two-way telephone call to a collaborative multi-media conference session.

SIP is an RFC standard from the Internet Engineering Task Force.

Generally, in IP networks, an IP network node may transfer calls of a mixture of different types of subscribers, e.g. IP type and non-IP type of subscribers.

IP type subscribers may comprise SIP, MGCP, DSL or other non-regulated type subscribers. Non-IP subscriber may comprise traditional POTS, TDM or other regulated subscriber types. As regards cable subscribers; they may be considered IP subscribers because they are unregulated. However, cable subscribers may also be considered as being non-IP type subscribers because they would typically have traditional TDM/non-IP features.

Thus, it is up to service providers to decide whether cable subscribers should be defined as IP or non-IP type subscribers.

If a service provider chooses to classify cable subscribers as non-IP type, an IP switch may host, beside IP-type subscribers such as SIP clients, non-IP type subscribers such as cable subscribers.

An IP switch, besides hosting several IP and non-IP subscribers, may also act as an interconnecting node for traditional non-IP subscribers hosted by a TDM switch.

In IP networks in which SIP protocol is used, it is useful to enable IP network nodes, in particular softswitches, to convey the subscriber type information to other IP network nodes when SIP protocol is used.

Methods were introduced in order to attempt to support signaling of subscriber type in SIP protocol.

Such methods provide add-on SIP extensions to signal bilateral agreements.

For example, a first method uses trunk groups <draft-ietf-iptel-trunk-group-04>.

Other methods are proprietary methods such as originating tenant groups.

A major drawback of the above introduced methods is that additional signaling elements have to be added in existing SIP headers.

A further method consists in allowing the interconnecting node to provision information on the subscriber type in its own database.

A drawback of this latter method is its impracticability because the subscriber-hosting and interconnecting nodes may be owned by different service providers.

It is therefore the aim of the present invention to overcome the above mentioned drawbacks, in particular by providing a method and a system for identification of subscriber type with SIP in which an interconnecting IP node is able of conveying the subscriber type to another IP interconnecting node.

The afore mentioned aim is achieved by a method and a system for identification of subscriber type with SIP protocol within a datacom network; the network comprising at least two network nodes and at least two subscribers; the at least two network nodes comprising at least two IP switches, the at least two switches being hereinafter referred as first switch and second switch; the at least two subscribers comprising at least one originating subscriber and at least one terminating subscriber; for the at least two subscribers defining a subscriber type, the subscriber type identifying whether the at least two subscribers are IP subscribers or non-IP subscribers; the first and second soft-switches being interconnected with each other and communicating with each other via SIP protocol in which Uniform Resource Identifiers of the originating subscriber are in form of userpart@hostpart; the Uniform Resource Identifier being hereinafter referred as URI; the userpart of the URI uniquely identifying the originating subscriber;

the invention comprising the steps of:
a) by the at least one originating subscriber, originating a call directed to the at least one terminating subscriber;
b) routing the call through the first switch and then through the second switch via SIP protocol;
c) by the first switch, identifying itself to the second switch through the hostpart of the URI ;
d) by the first switch signaling, via SIP protocol, to the second switch the subscriber-type of the at least one originating subscriber; and
e) using the hostpart of the step c) to define a logical grouping identifying the subscriber-type of the at least one originating subscriber.

In the invention the userpart of the URI uniquely identifying the originating subscriber may advantageously be in form of a telephone number.

The invention may advantageously comprise using, for the hostpart, at least two DN identifiers, identifying the subscriber-type of the at least one originating subscriber.

In the invention the at least two domain name identifiers may preferably resolve all to the same first switch.

The invention may advantageously comprise using, for the hostpart, at least two IP addresses identifying the subscriber-type of the at least one originating subscriber.

In the invention the at least two IP addresses may conveniently refer to the same first switch.

In the invention at least one of the at least two DN identifiers or of the at least two IP addresses may advantageously identify a TDM switch hosting the non-IP type subscribers and being associated to the first switch.

In the invention, when the originating IP subscriber is an IP-type subscriber, the IP-type subscriber may be selected from the group consisting of:
SIP client communicating with the first switch via SIP protocol;
cable subscriber communicating with the first switch via MGCP protocol.

In the invention the first switch may be in form of a server complex.

The invention may preferably comprise, by the second softswitch, determining via the hostpart of the URI the type of the originating subscriber.

The proposed invention utilizes standard SIP signaling.

In fact, the proposed invention does not require new add-on signaling elements to achieve bilateral signaling.

The proposed invention achieves interoperability improvements.

The proposed invention allows the interconnected node which is receiving the signaling information on the subscriber type to provide different processing depending on the received information.

In fact, by using the knowledge of the subscriber type, the interconnecting node receiving the subscriber-type information may be able to determine the tariff for billing the subscriber, since IP and non-IP subscribers typically have different tariff structures.

Additionally, by using the knowledge of the subscriber type, the available features for the various IP/non-IP subscriber types may also be determined.

The invention will now be described in preferred but not exclusive embodiments with reference to the accompanying drawing, wherein:

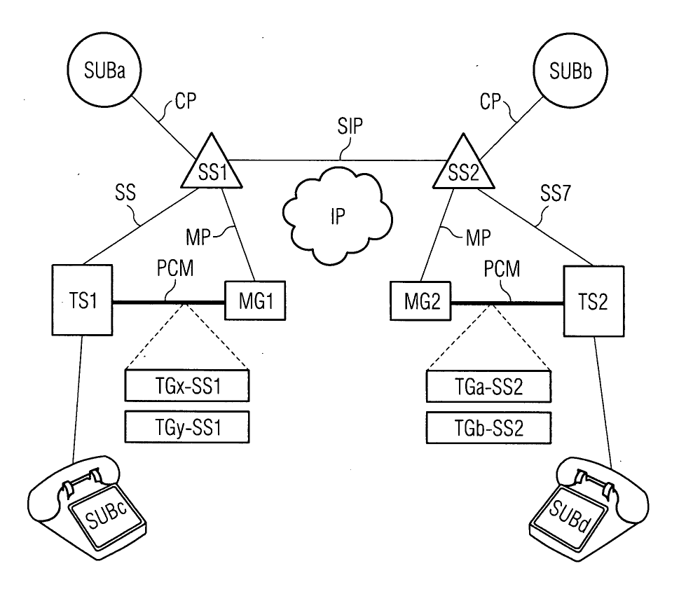

FIG. 1 a block diagram schematically illustrating an example of datacom network in which a call is originated.

In FIG. 1, four interconnecting network nodes SS1, SS2, TS1, TS2 are shown.

Network nodes SS1, SS2 represent two IP switches, in particular two softswitches.

Each of the IP switch SS1, SS2 may be identified by a plurality of IP addresses and may be in form of a server complex or server farm.

End-points SUBa, SUBb, SUBc, SUBd represent subscribers originating and receiving calls routed through the network nodes SS1, SS2, TS1, TS2.

Subscribers SUBa, SUBb, SUBc, SUBd may be of different types, in particular IP type and non-IP type.

For example, subscribers SUBa, SUBb are IP type subscribers hosted respectively by first and second softswitches SS1, SS2.

Examples of IP-type subscribers SUBa, SUBb may comprise SIP subscribers, e.g. Optipoint 400 and Win32 clients, or MGCP subscribers, e.g. cable modems/MTAs, when cable subscribers are classified as IP subscriber by a service provider.

In another example embodiment of the present invention cable subscribers SUBa, SUBb hosted by the softswitches SS1, SS2 may be non-IP type subscribers in case they are classified by the service provider as being non-IP type.

In the example network of FIG. 1, subscribers SUBc, SUBd are non-IP type subscribers hosted respectively by first TDM switch TS1 and by second TDM switch TS2.

As above said, subscribers SUBa, SUBb, SUBc, SUBd may be originator or terminator of calls. For example, originators of calls are originating subscribers SUBa, SUBc and terminator of calls are terminating subscribers SUBb, SUBd.

The two softswitches SS1, SS2 are IP interconnecting network nodes to the two TDM interconnecting nodes TS1, TS2 that host the non-IP subscribers SUBc, SUBd.

Connections CP between IP subscribers SUBa, SUBb and their hosting softswitches SS1, SS2 may be over SIP protocol, e.g. for SIP clients, or over MGCP, e.g. for MTAs.

Signaling protocols SIP and SS7 are used for internode signaling.

More in particular, SS7 protocol is used in connections SS7 between softswitches SS1, SS2 and TDM switches TS1, TS2, whereas SIP protocol is used in connection SIP between the two softswitches SS1, SS2.

First media-gateway MG1 and second media-gateway MG2 are respectively controlled by the first softswitch SS1 and the second softswitch SS2.

MGCP or H.248 protocol may be used in each connection MP between the softswitch SS1, SS2 and the media-gateways MG1, MG2.

In fact, the softswitch SS1, SS2 may include a Media Gateway Controller function to control media-gateways MG1, MG2 via such MGCP or H.248 protocol.

In general, the softswitches SS1, SS2, beside managing calls between its hosted subscribers SUBa, SUBb may be capable of managing voice calls originated from or terminated to TDM-switch hosted subscribers SUBb, SUBd.

To do so, the softswitches SS1, SS2 control the voice connections within a logical trunk group (LTG) via connections MP to the media-gateway MG1, MG2 and via signaling connections SS7 to the TDM switches TS1, TS2.

The connections PCM between each TDM-switch TS1, TS2 and each media-gateway MG1, MG2 are TDM connections.

The low level data format of the connections PCM may be either T1 or E1.

The TDM circuits of the PCM connections are LTGS. A LTG is a group of TDM circuits, e.g. T1 or E1 channels, from which an individual channel or time slot is selected for a given call. For example, LTGs TGx-SS1, TGy-SS1 are under the control of the first softswitch SS1 via its media-gateway MG1 and LTGs TGa-SS2, TGb-SS2 are LTGs under the control of the second softswitch SS2 via its media-gateway MG2.

Since the first softswitch SS1 has visibility on TDM logical trunk groups (LTG) LTGx-SS1, LTGy-SS1 used to interconnect to the TDM network, it is able to know if originating subscribers SUBa, SUBc are of IP-type, hosted by the softswitch SS1 itself, or of non-IP type, hosted by the TDM switch TS1.

During a call, one of the originating subscribers SUBa, SUBc originates a call directed to one of the terminating subscribers SUBb, SUBd.

The originated call from one of the originating subscribers SUBa, SUBc is routed to first softswitch SS1 and then to the second softswitch SS2.

In case of a non-IP type originating subscriber SUBc, the originated call is arriving to the first softswitch SS1 via the TDM switch TS1, hosting the TDM originating subscriber SUBc.

The two softswitches SS1, SS2 communicate with each other via SIP requests.

The URI of a SIP request is typically in the form of userpart@hostpart.

For example, an INVITE request has a FROM header that contains information on originating party SUBa, SUBc and has a TO header that contains information on terminating party SUBb, SUBd. Both FROM and TO headers have a URI parameter that identifies the respective originating or terminating party SUBa, SUBb, SUBC, SUBd.

According to the present invention, the userpart of the originating subscriber URI of the inter-softswitch SIP request uniquely identifies the originating subscriber SUBa, SUBc globally or with regard to the softswitch network.

According to an embodiment according to the present invention, the userpart may be in form of a telephone number having global meaning. In particular, the telephone number may be represented in the global number format according to the RFC3966 Internet standard.

The first softswitch SS1, when communicating via SIP with the second softswitch SS2, identifies itself via the hostpart of the URI.

According to the present invention, the first softswitch SS1 signals to the second softswitch SS2 the type of the originating subscribers SUBa, SUBc by using the hostpart of the URI to identify a logical grouping of originating users SUBa, SUBc uniquely identified by their userpart.

This logical grouping acts as a bilateral agreement between the involved soft-switches.

The second softswitch SS2 is able to analyze the hostpart of the URI so as to identify the type of the originating subscriber SUBa, SUBc.

The second softswitch SS2 operates upon the signaled bilateral agreement and does not attempt to resolve the hostpart to a routing address either via DNS translation or via direct routing to IP address.

Advantageously, once the second switch SS2 knows the subscriber type as being IP or non-IP type thorough the signaling of the first softswitch SS1, it may determine the different available features or billing tariffs for the originating subscriber SUBa, SUBc.

In a further embodiment according to the present invention, the first softswitch SS1 uses as hostpart one of at least two DN identifiers, depending on whether the originating subscriber type is IP or non-IP type.

Preferably the DN identifiers may be in the form of FQDNS.

In a further embodiment according to the present invention, the two DN identifiers may both identify the same physical softswitch SS1 through which the SIP request routes.

In a further embodiment according to the present invention, one of the two DN identifiers identifies the TDM switch SS1 associated to the first softswitch SS1.

In this latter embodiment, there may be other elements such as DNS server in the network that provide service routing paths within SIP through SS1, for example to reach the respective designated switch identified by the DN identifiers.

This latter embodiment may be needed for inter-domain scenarios, for example between carriers or network providers.

In a further embodiment according to the present invention, the first softswitch SS1 uses as hostpart one of at least two IP addresses, depending on whether the originating subscriber SUBa, SUBc of the call is of an IP or non-IP type.

The skilled in the art easily understands that, in a further embodiment of the present invention, the logical grouping may be obtained also by using multiple, i.e. more than two, IP addresses or DN identifiers.

Below are given some examples of originating subscriber URIs used as FROM headers in SIP INVITE requests by the first softswitch SS1 according to the present invention.

In case the IP originating subscriber SUBa is a SIP client, its URI may be in the form

“sip:19725551231@SIPx.SS1.sipnet.com” in which SIPx identifies a call originated from a SIP client.

In case the non-IP originating subscriber SUBc is a TDM user, its URI may be in the form

“sip:19725551233@TGx.SS1.sipnet.com” in which TGx identifies a call originated from a trunk group.

In case the originating subscriber SUBa is a cable subscriber, its URI may be in the form

“sip:19725551232@MTAx.SS1.sipnet.com” in which MTAX identifies a call originated from a MTA, which may be interpreted as IP or non-IP depending on the classification chosen by the service provider.

### LIST OF USED REFERENCE SIGNS

CP connection between IP subscribers and softswitches

MP connection between media-gateway and softswitch

PCM connection between TDM switch and media-gateway

SUBa originating subscriber

SUBb terminating subscriber

SUBc originating subscriber

SUBd terminating subscriber

SS1, SS2 IP switches, softswitches

SS7 connection between softswitch and TDM switched

TGx-SS1 logical trunk group

TGy-SS1 logical trunk group

TGa-SS2 logical trunk group

TGb-SS2 logical trunk group

TS1, TS2 TDM switches

SIP connection between softswitches

### LIST OF USED ACRONYMS

DN domain name

DNS domain name server

DSL digital subscriber line

E1 E-carrier level 1

FQDN fully qualified domain name

IP internet protocol

LTG logical trunk group

MGCP media gateway control protocol

MTA multimedia terminal adapter

POTS plain old telephone service

PSTN public switched telephone network

RFC request for comment

SIP session initiation protocol

SS7 signaling system number 7

T1 T-carrier level 1

URI uniform resource identifier

### LIST OF USED INDUSTRY SPECIFICATIONS AND STANDARDS

RFC 3966 The URI for Telephone Numbers

RFC 3261 Session Initiation Protocol (SIP)

1. A method for identification of a subscriber type with SIP protocol within a datacom network;
said network comprising at least two network nodes and at least two subscribers;
said at least two network nodes comprising at least two IP switches, said at least two switches being hereinafter referred as first switch and second switch;
said at least two subscribers comprising at least one originating subscriber and at least one terminating subscriber;
for said at least two subscribers defining a subscriber type, said subscriber type identifying whether said at least two subscribers are IP subscribers or non-IP subscribers;
said first and second soft-switches being interconnected with each other and communicating with each other via SIP protocol in which Uniform Resource Identifiers (URI) of said originating subscriber are in form of userpart@hostpart; said userpart of said URI uniquely identifying said originating subscriber;
said method comprising the steps of:
a) by said at least one originating subscriber originating a call directed to said at least one terminating subscriber;
b) routing said call through said first switch and then through said second switch via SIP protocol;
c) by said first switch, identifying itself to said second switch through said hostpart of said URI;
d) by said first switch signaling, via SIP protocol, to said second switch the subscriber-type of said at least one originating subscriber; and
e) using said hostpart to define a logical grouping identifying the subscriber-type of said at least one originating subscriber.

2. The method according to claim 1, wherein said userpart of said URI uniquely identifying said originating subscriber is in form of a telephone number.

3. The method according to claim 1, wherein said step e) further comprises:
using, for said hostpart, at least two Domain Name identifiers, identifying the subscriber-type of said at least one originating subscriber.

4. The method according to claim 3, wherein said at least two domain name identifiers resolve all to the same first switch.

5. The method according to claim 1, wherein said step e) further comprises:
using, for said hostpart, at least two IP addresses identifying the subscriber-type of said at least one originating subscriber.

6. The method according to claim 5, wherein said at least two IP addresses refer to the same first switch.

7. The method according to claim 3,
wherein at least one of said at least two Domain Name identifiers or of said at least two IP addresses identifies a TDM switch hosting said non-IP type subscribers and being associated to said first switch.

8. The method according to claim 1, wherein, when said originating IP subscriber is an IP-type subscriber, said IP-type subscriber is selected from the group consisting of:
SIP client communicating with said first switch via SIP protocol; and
cable subscriber communicating with said first switch via MGCP protocol.

9. The method according to claim 1, wherein said first switch is in form of a server complex.

10. The method according to claim 1, further comprising:
by said second softswitch, determining via said hostpart of said URI the type of the originating subscriber.

11. A system for identification of subscriber type with SIP protocol within a datacom network;
said network comprising at least two network nodes and at least two subscribers;
said at least two network nodes comprising at least two IP switches, said at least two switches being hereinafter referred as first switch and second switch;
said at least two subscribers comprising at least one originating subscriber and at least one terminating subscriber;
for said at least two subscribers, defining a subscriber type, said subscriber type identifying whether said at least two subscribers are IP subscribers or non-IP subscribers;
said first and second soft-switches being interconnected with each other and communicating with each other via SIP protocol in which Uniform Resource Identifiers (URI) of said originating subscriber are in form of userpart@hostpart; said userpart of said URI uniquely identifying said originating subscriber;
said system comprising:
f) in said at least one originating subscriber, means for originating a call directed to said at least one terminating subscriber;
g) means for routing said call through said first switch and then through said second switch via SIP protocol;
h) in said first switch, means for identifying itself to said second switch through said hostpart of said URI;
i) in said first switch, means for signaling, via SIP protocol, to said second switch (SS2) the subscriber-type of said at least one originating subscriber, wherein
said means for signaling comprise means for using said hostpart to define a logical grouping identifying the subscriber-type of said at least one originating subscriber.
